(19) United States
(12) Patent Application Publication
(10) Pub. No.: US 2013/0316770 A1
(43) Pub. Date: Nov. 28, 2013

(54) KNIFE-SHARPENING SYSTEM FOR AN INFEED CUTTER OF AN AGRICULTURAL IMPELMENT

(71) Applicant: AGCO Corporation, (US)

(72) Inventor: Alan Haycocks, Kenilworth (GB)

(73) Assignee: AGCO CORPORATION, Duluth, GA (US)

(21) Appl. No.: 13/727,698

(22) Filed: Dec. 27, 2012

Related U.S. Application Data
(60) Provisional application No. 61/581,007, filed on Dec. 28, 2011.

(51) Int. Cl. A01F 15/10

(52) U.S. Cl. CPC A01F 15/10
USPC 460/22

(57) ABSTRACT

An agricultural implement having an infeed cutter includes a plurality of knives and at least one knife-sharpening assembly. The knives are mounted on shiftable knife beds that swing into and out of an operating position. The beds are laterally slidable in opposite directions to provide access to the knives. The knife-sharpening assembly includes a hood and a plurality of sharpening stones mounted on a shaft that moves along a path corresponding to the shape of the cutting edges of the knives, meaning the sharpening stones preferably follow the substantially arcuate contour of the uppermost edges of the knives during the course of sharpening. The hood is configured to contain any sparks produced by the interaction between the stones and knives. The knife beds and sharpening assemblies are configured such that sufficient ground clearance for travel of the agricultural vehicle is available during sharpening of the knives.

### CROSS-REFERENCE TO RELATED APPLICATIONS

This application claims priority to U.S. Provisional Application No. 61/581,007 filed Dec. 28, 2011, entitled “KNIFE-SHARPENING SYSTEM FOR AN INFEED CUTTER OF AN AGRICULTURAL IMPLEMENT”.

### BACKGROUND OF THE INVENTION

This invention relates to agricultural balers, and more particularly, to a knife sharpening system for an infeed cutter of an agricultural baler.

### SUMMARY OF THE INVENTION

An agricultural implement having an infeed cutter includes a plurality of knives and at least one knife-sharpening assembly for sharpening of the knives. The knives are preferably mounted on a pair of shiftable knife beds that swing (as is customary) into and out of an operating position. The beds are also laterally slidable in opposite directions so as to provide easy access to the knives. Preferably, the implement includes a pair of knife-sharpening assemblies. Each knife-sharpening assembly comprises a hood and a plurality of sharpening stones mounted on an at least substantially horizontally extending shaft. The sharpening stones are configured for engagement with the knives. The shaft is mounted such that it moves along a path corresponding to the shape of the cutting edges of the knives, meaning the sharpening stones preferably follow the substantially arcuate contour of the uppermost edges of the knives during the course of sharpening. The hood is configured to contain any sparks produced by the interaction of the stones and the knives. The knife beds and sharpening assemblies are configured such that sufficient ground clearance for travel of the agricultural vehicle is available during sharpening of the knives.

### BRIEF DESCRIPTION OF THE DRAWING FIGURES

Preferred embodiments of the invention are described in detail below with regard to the attached drawing figures, wherein:

FIG. 1 is a side elevational view of a baler having features found in a preferred embodiment of the present invention;

FIG. 2 is an enlarged, fragmentary, longitudinal cross-sectional view through the infeed part of the baler of FIG. 1, illustrating the relationship between the pickup, cutter apparatus, packer, and stuffer;

FIG. 3 is fragmentary longitudinal cross-sectional view similar to that of FIG. 2 but taken somewhat deeper into the baler of FIGS. 1 and 2 to illustrate the relationship between the cutter rotor and strippers associated with the rotor;

FIG. 4 is a fragmentary side elevational view of the infeed area of the baler of FIGS. 1-3, illustrating the latching and release mechanism for the knife bed associated with the cutter apparatus;

FIG. 5 is a fragmentary side elevational view similar to FIG. 4 but showing the knife bed of the baler of FIGS. 1-4 in its fully lowered position;

FIG. 6 is a left, front isometric view of the cutter apparatus of the baler of FIGS. 1-5;

FIG. 7 is a left, rear isometric view of the cutter apparatus of the baler of FIGS. 1-6;

FIG. 8 is a schematic top view of a baler having features found in a preferred embodiment of the present invention, illustrating a laterally moveable split knife bed for ease of access to the knives;

FIG. 9 is a schematic left, rear isometric view of a preferred embodiment of the inventive baler, illustrating the left knife bed in a lateral position and the left sharpening assembly in a storage position;

FIG. 10 is a schematic left, rear isometric view of the inventive baler of FIG. 9, illustrating the left knife bed and the left sharpening assembly interlocked for implementation of the sharpening process; and

FIG. 11 is a schematic left, rear isometric view of the left sharpening assembly of the inventive baler of FIGS. 9 and 10.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

In a preferred embodiment, the agricultural machine featuring the inventive blade-sharpener is a baler for making rectangular crop bales. However, it is within the scope of the present invention for the blade-sharpener to be part of any of a variety of agricultural machines having an infeed cutter. These machines include round balers, silage trailers, forage harvesters, and others. In the most preferred form, the inventive aspects are used with an implement having a pickup associated with an infeed cutter, wherein the pickup presents a maximum width that is greater than the width of the trailing baling chamber or crop collection trailer or wagon.

In a preferred embodiment, the baler of the present invention includes many of the features disclosed in U.S. Pat. No. 6,595,123 to Schrag et al. (the Schrag et al. '123 patent), issued Jul. 22, 2003, and entitled KNIFE BED ASSEMBLY FOR BALERS, which is attached as Appendix A and is hereby incorporated in its entirety by reference herein.

In another preferred embodiment, the baler of the present invention includes many of the features disclosed in U.S. Pat. No. 6,679,042 to Schrag et al. (the Schrag et al. '042 patent), issued Jan. 20, 2004, and entitled INFEED CUTTER BALER HAVING INCREASED THROUGHPUT, which is attached as Appendix B and is hereby incorporated in its entirety by reference herein.

In yet another preferred embodiment, the baler of the present invention includes many of the features disclosed in U.S. Pat. No. 4,945,719 to Schrag et al. (the Schrag et al. '719 patent), issued Aug. 7, 1990, and entitled SQUARE BALER HAVING PLUNGER CLEANOUT APPARATUS, which is attached as Appendix C and is hereby incorporated in its entirety by reference herein.

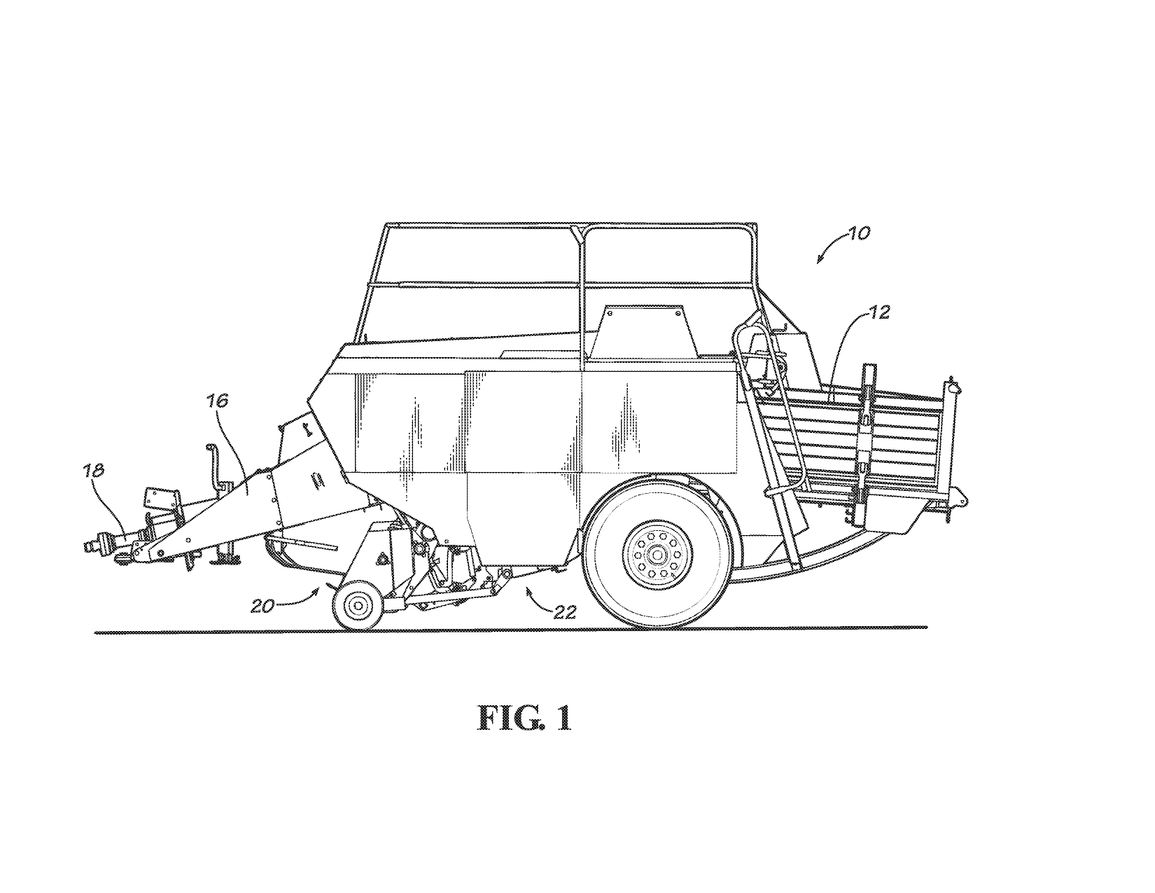

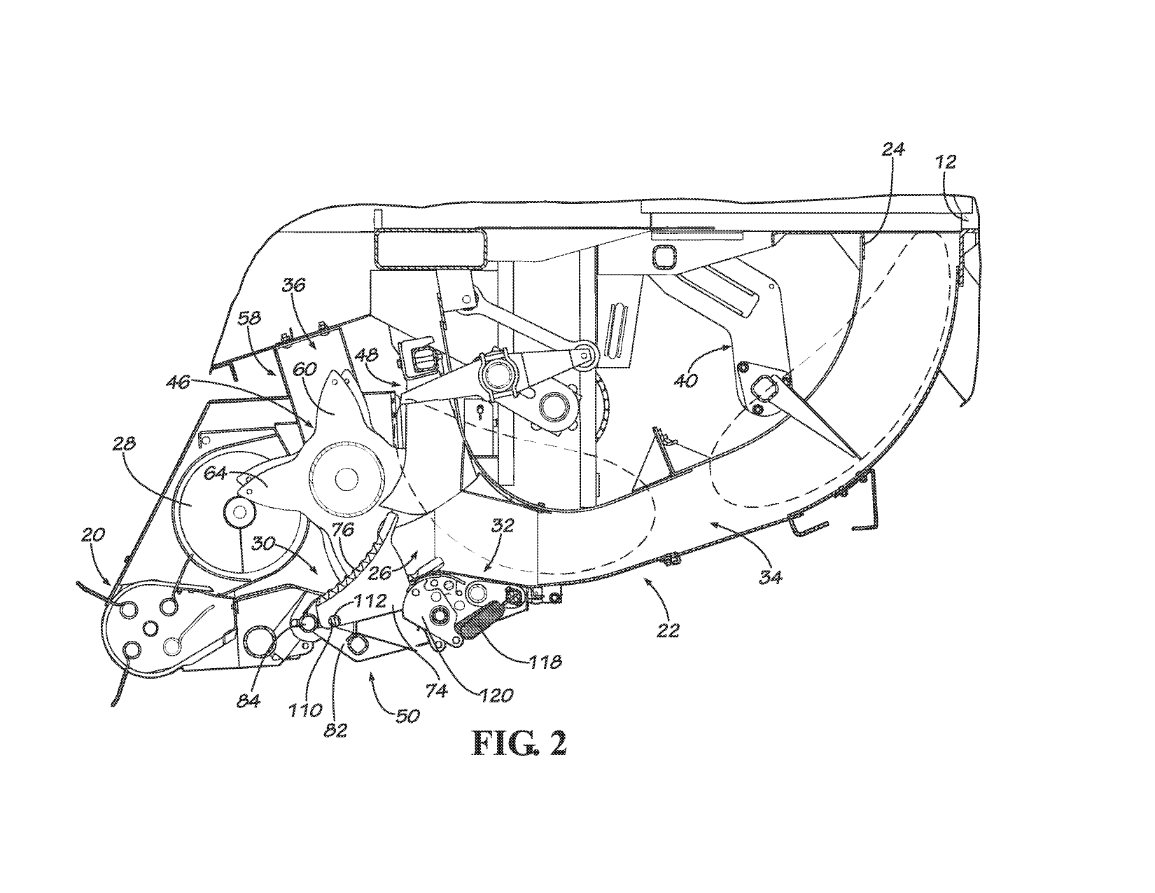

As best shown in FIG. 1, the baler 10 preferably includes a fore-and-aft extending baling chamber, broadly indicated by numeral 12, within which bales of hay are prepared and forced incrementally out the back end of the chamber 12. The baler 10 is hitched to a towing vehicle (not shown) by a fore-and-aft tongue 16, and power for operating the various components of the baler 10 is supplied through a drive line 18 supported by the tongue 16. Preferably, the baler 10 is an “in-line” type of baler wherein crop is picked up directly beneath and slightly ahead of the baling chamber 12 and loaded up into the bottom of the chamber 12 in a straight line path of travel as viewed from the top, although other crop routing configurations may be used without departing from the spirit of the present invention. In keeping with the preferred in-line arrangement, the baler 10 shown in FIG. 1 has a pickup 20 positioned under the tongue 16 such that the pickup 20 is significantly forward of the baling chamber 12. A duct 22, barely visible in FIG. 1, extends generally rearwardly and upwardly from behind the pickup 20 to an opening 24 (see FIG. 2) in the bottom of the baling chamber 12. The duct 22 serves as part of a passage through which crop materials travel from the pickup 20 to the baling chamber 12 during operation of the baler 10.

With primary reference to FIG. 2, it will be seen that the infeed area of the baler 10 generally comprises a passage broadly denoted by the numeral 26 for crop flow that begins just rearwardly of the pickup 20 and ends at the opening 24 in the bottom of the baling chamber 12. Although the crop materials are initially lifted off the ground by the pickup 20 in a relatively wider configuration than the width of the duct 22, such materials are immediately consolidated centrally by an auger mechanism 28 before entering the passage 26. As the consolidated stream of crop materials moves rearwardly from the auger mechanism 28, it passes through a cutting zone 30 immediately behind the pickup 20. The crop materials then pass through a packing zone 32 behind the cutting zone 30 and through an accumulating zone 34 behind the packing zone 32. Within the cutting zone 30, the crop materials are cut into smaller pieces. Within the packing zone 32, the materials have a packing and feeding force applied to them in the downstream direction of flow. Within the accumulating zone 34, the materials accumulate into a charge that is compressed by the packing force and that assumes the configuration of the duct 22 in that area. A stuffer 40 then sweeps the charge up into the baling chamber 12 through the opening 24.

In order to carry out the cutting function within the cutting zone 30, the baler includes a cutter apparatus broadly denoted by the numeral 36. The cutter apparatus 36 comprises three primary components: a cutter rotor 46, a bank of strippers 48 for the rotor 46, and a knife bed 50 cooperating with the rotor 46 to sever the crop materials into smaller pieces. The rotor 46 preferably comprises a series of generally star-shaped blades 60 arranged in a helical or spiral pattern as shown, although V-shaped arrangements or a variety of others are permissible, as well.

Preferably, the rotor 46 is driven in a counter-clockwise direction as viewed from the vantage point of FIG. 2, such that the blades 60 sweep downwardly and forwardly into the cutting zone 30 on the front side of the axis of rotation of the rotor. Conversely, the blades 60 swing upwardly and rearwardly out of the cutting zone 30 behind the axis of rotation of the rotor 46. Thus, crop materials lifted from the field by the picker 20 are propelled by the rotor 46 rearwardly through the cutting zone 30. Crop materials which might tend to be carried by the rotor 46 after the crop materials have passed behind the axis of rotation of the rotor 46 are stripped therefrom by the strippers 48, at which point the crop materials enter the packing zone 32.

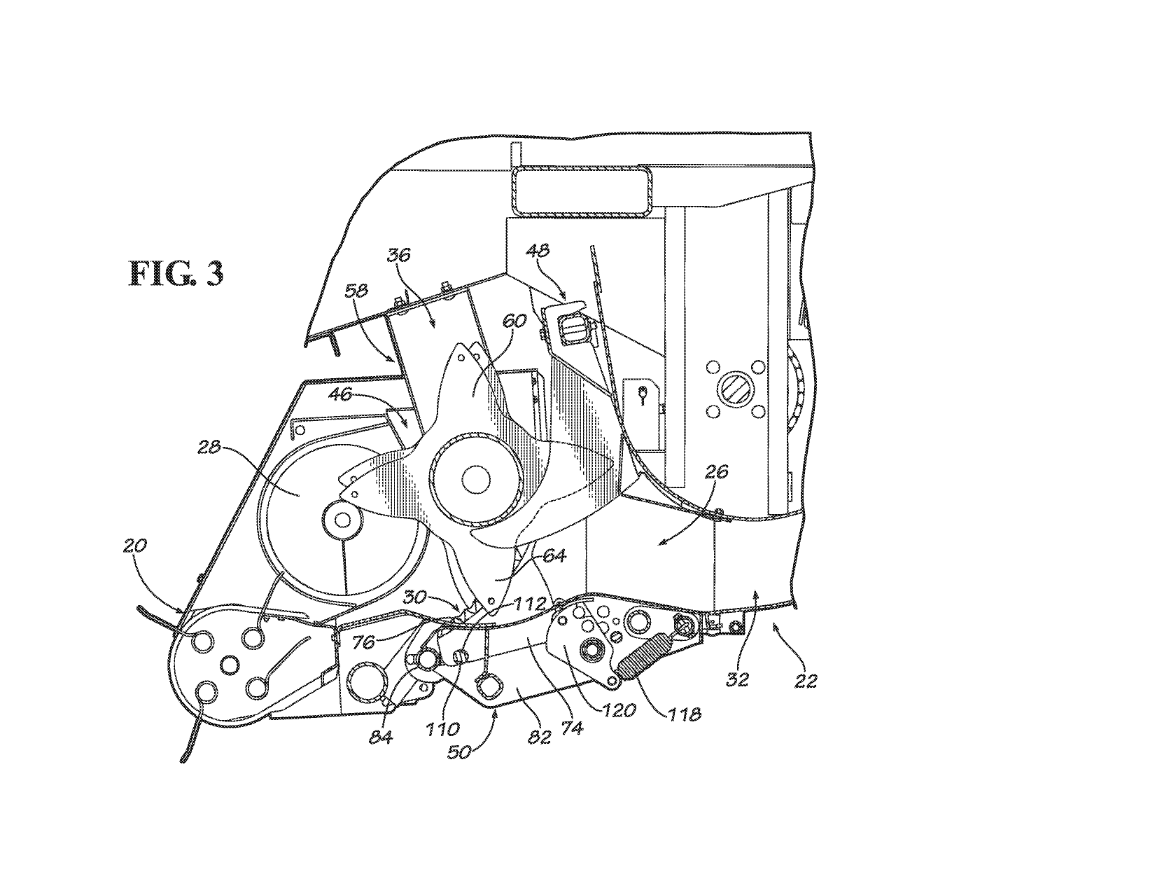

Referring primarily to FIGS. 2 and 3, the knife bed 50 includes a series of knives 74 that cooperate with the points 64 of the blades 60 to reduce incoming crop materials into small pieces when the knives 74 are in their raised, operating positions as illustrated, for example, in FIG. 3. The knives 74 are arranged to project upwardly between each pair of blades 60 so that as the points 64 on a pair of blades sweep downwardly and then rearwardly through the cutting zone 30, they pass on opposite sides of a corresponding knife 74. As shown in FIG. 3, each of the knives 74 has a serrated cutting edge 76 that faces generally upwardly and forwardly when the knife is in its operating position. Although they are not visible in the provided figures, the sides of knives 74 opposite the serrated cutting edge 76 are generally smooth. As shown in FIG. 6, the knives 74 project up through slits 78 in a top wall 80 of the bed 50 when knives 74 are in their operating positions.

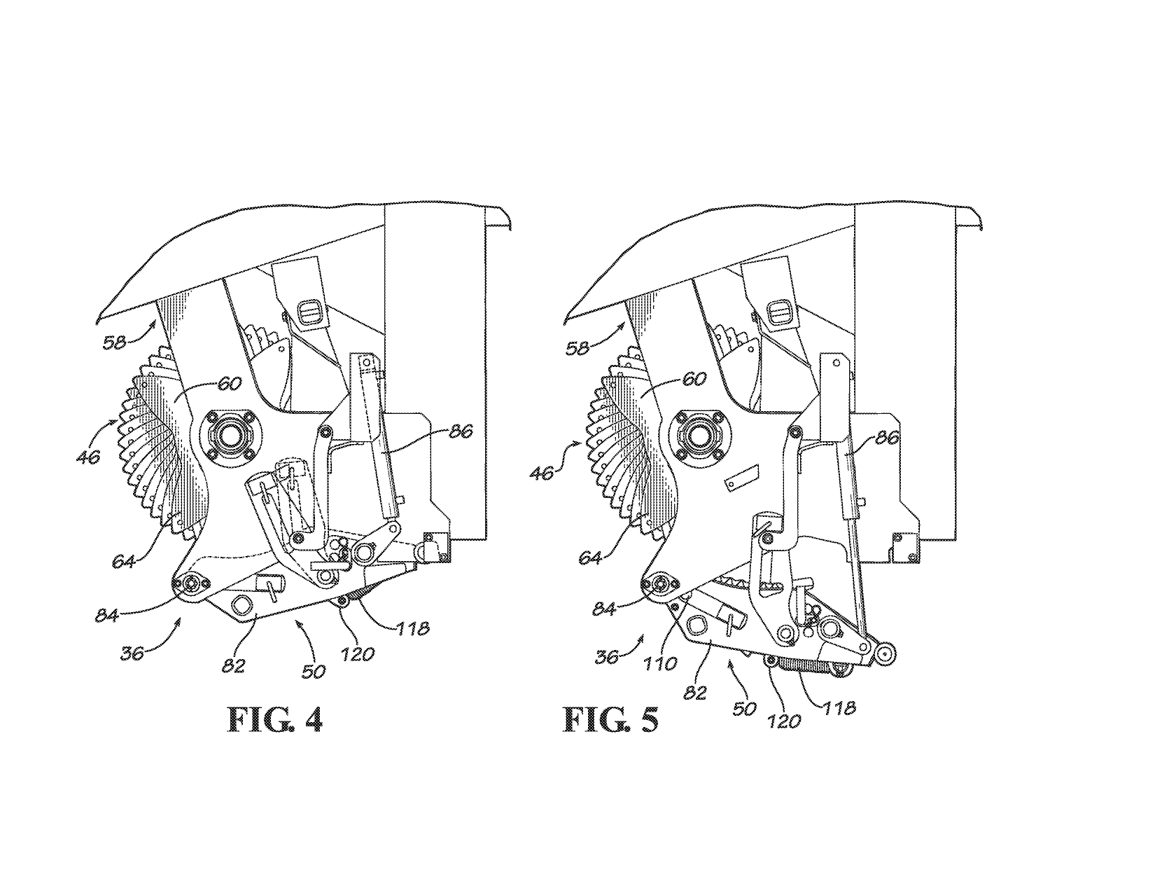

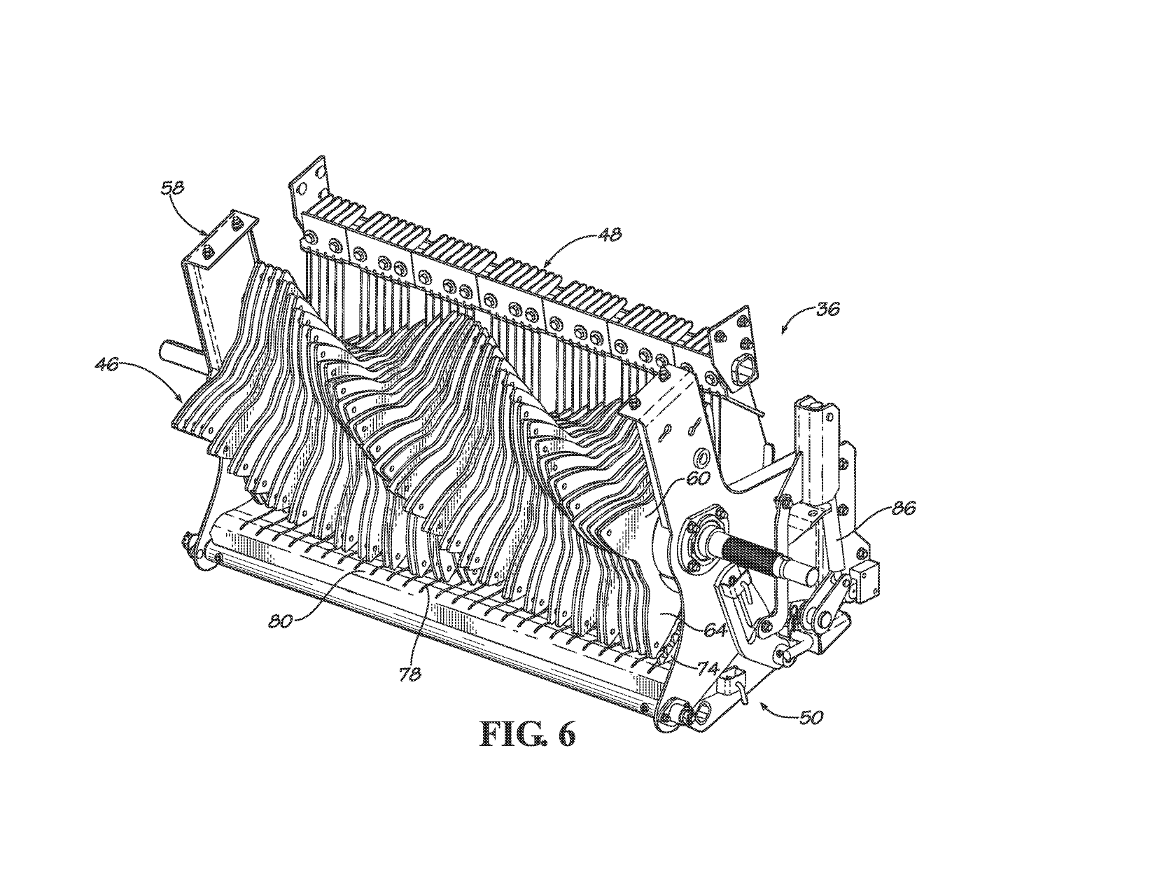

As shown in FIG. 3 and others, the knives 74 are carried by a subframe 82 forming another part of the bed 50. Subframe 82 is connected to the supporting frame 58 for the rotor 46 adjacent the lower forwardmost extremity of frame 58 by a transverse pivot shaft 84 so that the entire knife bed 50 can be raised and lowered between the two extreme positions illustrated in FIGS. 4 and 5. Such raising and lowering is preferably controlled by a pair of hydraulic cylinders 86 on opposite sides of the baler (see, for instance, FIGS. 4 and 5), although a variety of control means fall within the scope of the present invention.

The knives 74 are all mounted at their forward ends onto a common cross shaft 110 that extends the full width of bed 50. A generally circular notch 112 (best viewed in FIGS. 2 and 3) in the lower edge of each knife 74 receives the cross shaft 110. Cross shaft 110 has a pair of opposed flat sides which enable each individual knife 74 to be removed from cross shaft 110 when cross shaft 110 is rotated to a position aligning the flat sides thereof with the entrance into the notch 112 of the knife. At other times, the cross shaft 110 is maintained in such a rotative position that the flat sides thereof are generally transverse to the entrance to the notch 112 of each knife so that the knives cannot be removed from cross shaft 110. As seen in FIG. 5, access to the knives 74 for removing and replacing the same is provided when the bed 50 is in its lowered position.

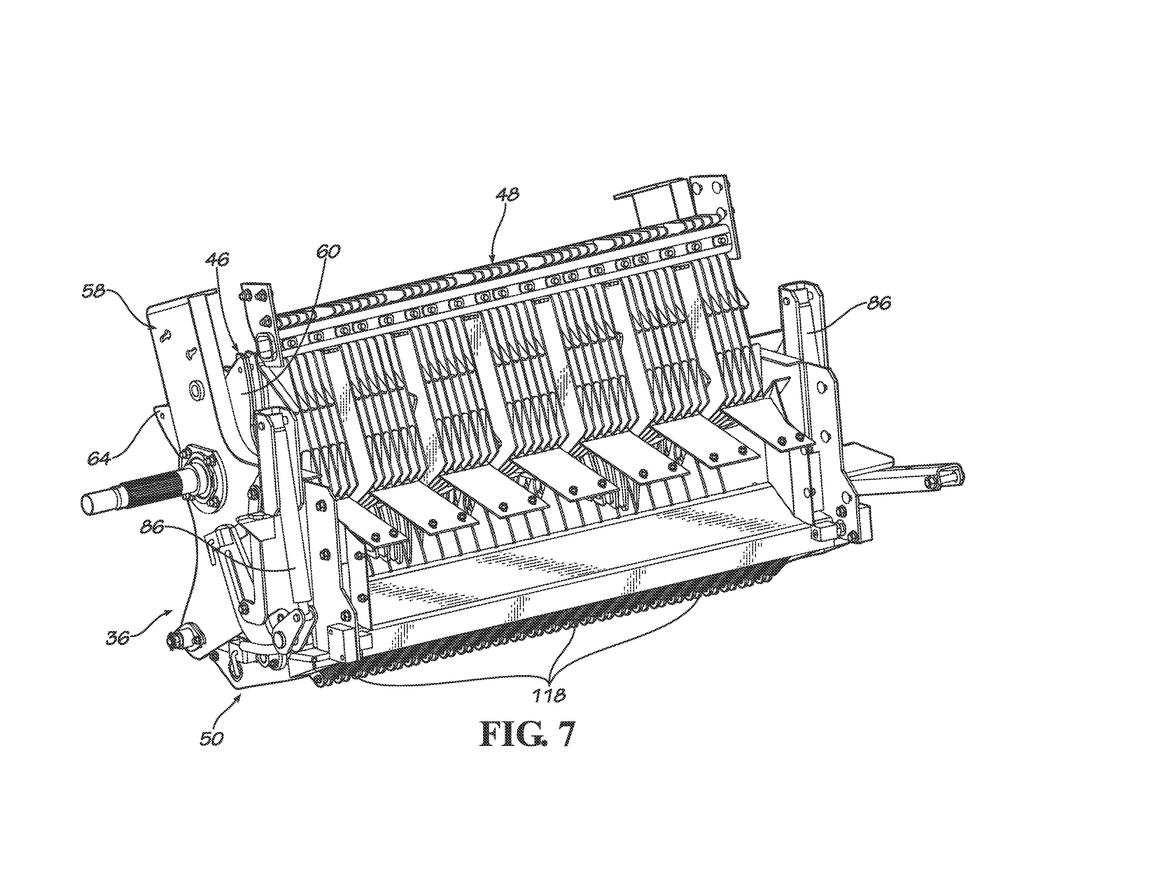

As best shown in FIGS. 2, 3, and 7, the knives 74 are all individually spring-loaded by a series of coiled extension springs 118 at the back of the knife bed 50. Thus, if a particular knife 74 is raised up into an operating position within the cutting zone 30 as illustrated in FIGS. 2 and 3, the knife can swing down about the cross shaft 110 against the force of its spring 118 in the event that an obstruction or solid object passes through the cutting zone 30 and engages the knife.

The number of knives 74 which are raised up into their operating position when the bed 50 is in its operating position can be selectively varied through control of actuators 120. More particularly, this can be carried out by controlling which of the actuators 120 are allowed to rotate back into their actuated positions by the springs 118 as the bed 50 is raised up into its operating position. In a preferred embodiment, this is accomplished by having the total set of actuators 120 constructed in four different configurations that render it possible to prevent every third actuator from returning, prevent every other actuator from returning, or prevent none of the actuators from returning. In the lattermost situation, all of the knives 74 are thus raised back up to their operating position.

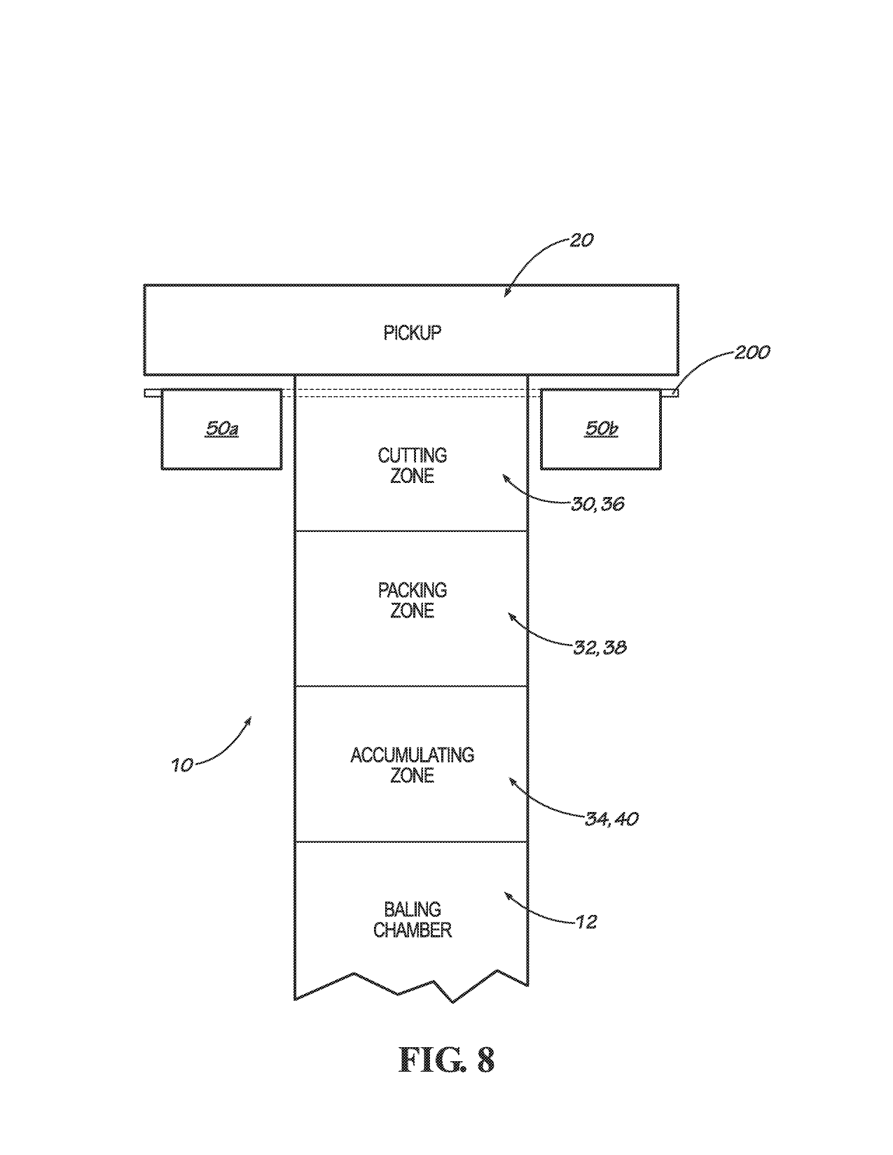

In a preferred embodiment, the knife bed 50 comprises left and right knife beds 50a,50b that retain the features described above but are additionally mobile laterally away from the center of the baler 10. For instance, as shown schematically in FIG. 8, the left and right knife beds 50a,50b, having been previously lowered into inoperative positions, have been slid horizontally along a laterally extending shaft 200 into accessible positions near the lateral margins of the baler 10. In a preferred embodiment, shaft 200 is simply an extension of the transverse pivot shaft 84.

In these accessible position, the beds 50a,50b and, in turn, the knives 74 (not shown in FIG. 8) carried on them, can be easily accessed by an operator for maintenance purposes, troubleshooting, etc. The movement of knife beds 50a,50b can be manual or automatic and may be implemented by a variety of means. For instance, a handle could be provided for manual sliding upon release of a latch, or a hydraulic system controlled by the operator from the cab could be implemented.

Although the embodiment shown in FIG. 8 features horizontally slidable beds 50a,50b, alternative paths and means of movement of the beds 50a,50b to an accessible position fall within the scope of the present invention. For instance, each of the beds 50a,50b could be laterally pivotable about a vertical axis, or the beds could be mounted on rollers carried on laterally extending tracks.

In a preferred embodiment, the pickup 20 has a width of three (3) meters, while each of the knife beds 50a,50b has a width of six tenths of a meter (0.6 meters). However, dimensional variations in any of the components of the baler 10 may be made without departing from the spirit of the present invention.

In a preferred embodiment, between eight (8) and twelve (12) knives 74 are provided on each of the beds 50a, 50b. However, any number of knives 74 may be present without departing from the spirit of the present invention.

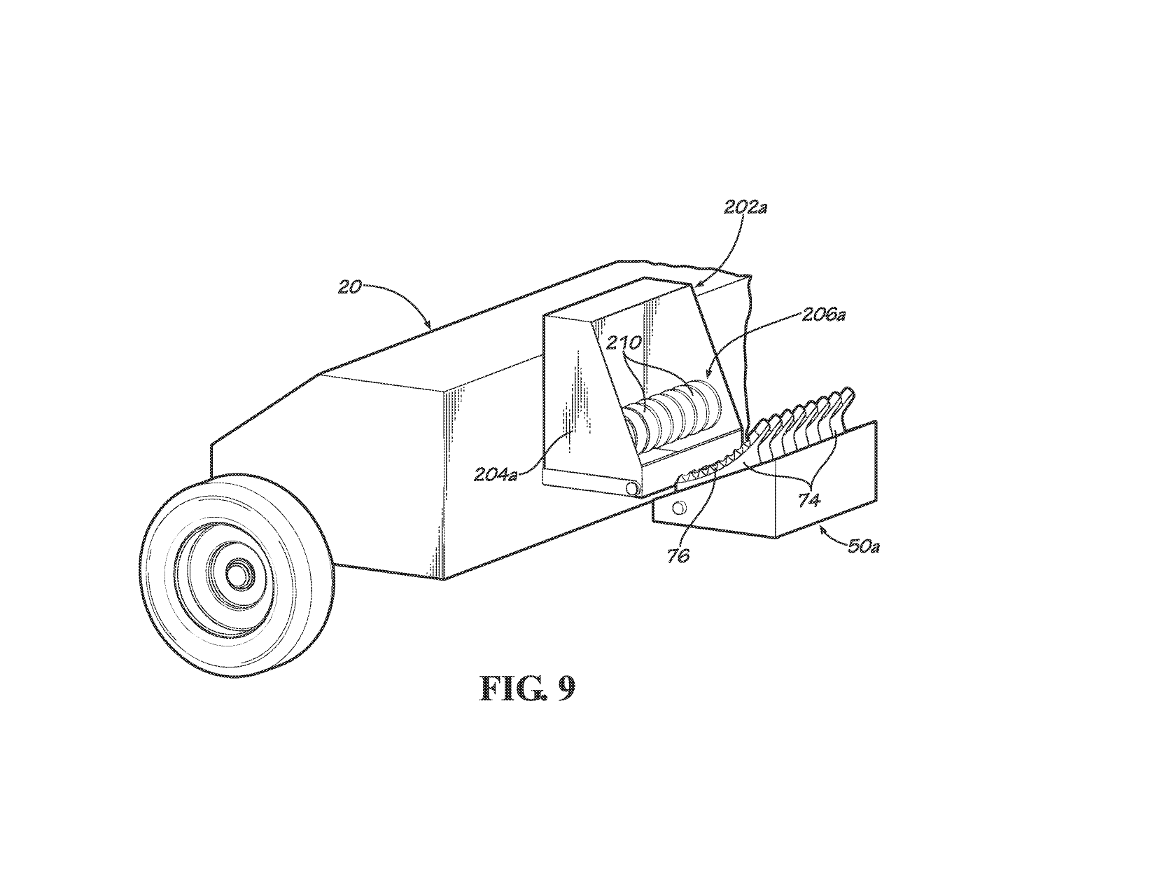

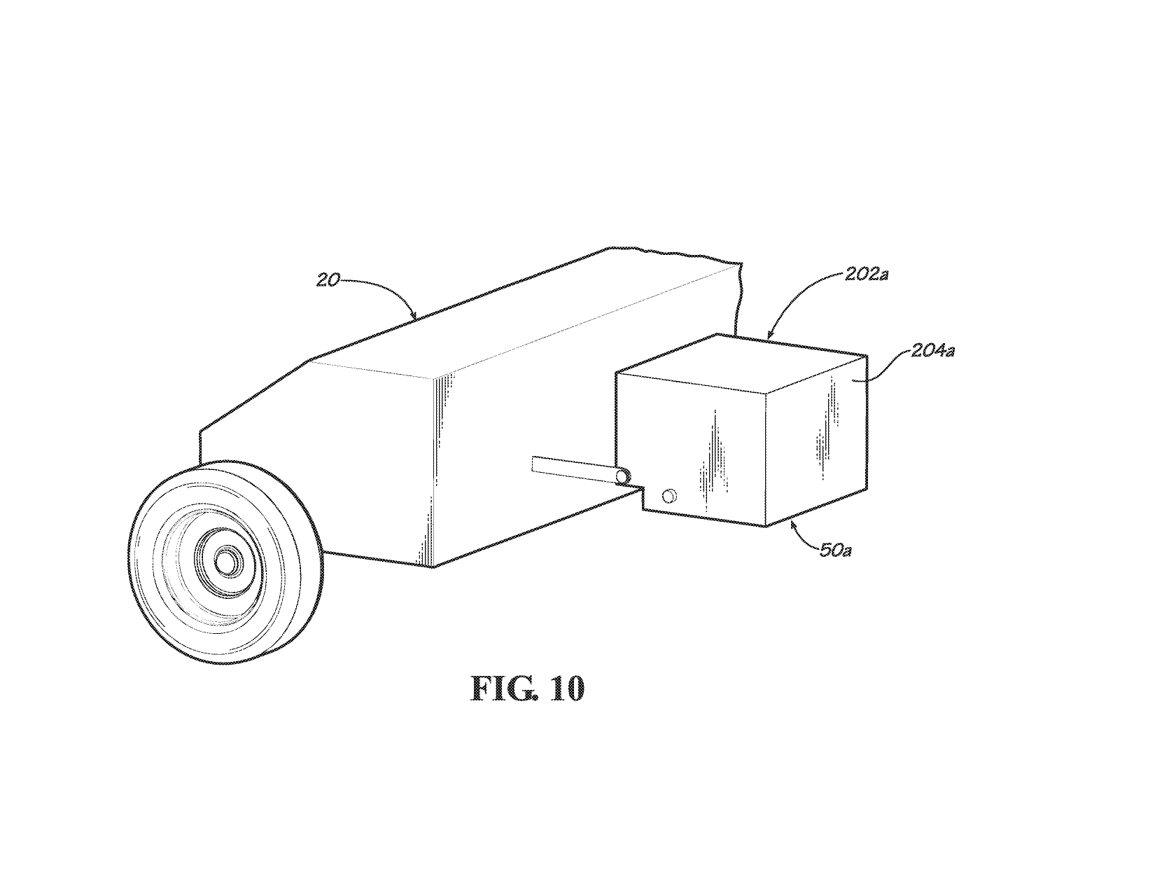

In a preferred embodiment best illustrated by FIGS. 9 and 10, at least one knife-sharpening assembly 202 is carried on the baler 10. The baler 10 preferably includes a sharpening assembly for each knife bed section (the number of which may be varied without departing from the spirit of the present invention), and the illustrated embodiment of FIGS. 9 and 10 consequently includes a pair of sharpening assemblies 202a,202b to correspond the pair of knife beds 50a,50b. However, it is within the scope of the present invention for any number of knife-sharpening assemblies 202 to be present.

As shown schematically in FIG. 9, the left and right sharpening assemblies 202a,202b are preferably mounted on the baler 10 behind the pickup 20 and laterally outside the cutting zone 30. These mounting positions are very convenient with the illustrated embodiment. For instance, because the pickup 20 is wider than the baling chamber 12, an area is provided on each side of the baling chamber 12 in which each assembly 202 can be tucked away without interfering with operation of the remaining machine components or increasing the overall width of the machine. When the baler 10 is operating, the sharpening assemblies 202 are thus positioned so as to avoid obstruction of the cutting process or any of the baling processes. Although the lateral mounting position illustrated in FIG. 9 is preferred, a variety of mounting positions that allow the baling processes to be conducted without obstruction by the sharpening assemblies 202 fall within the spirit of the present invention.

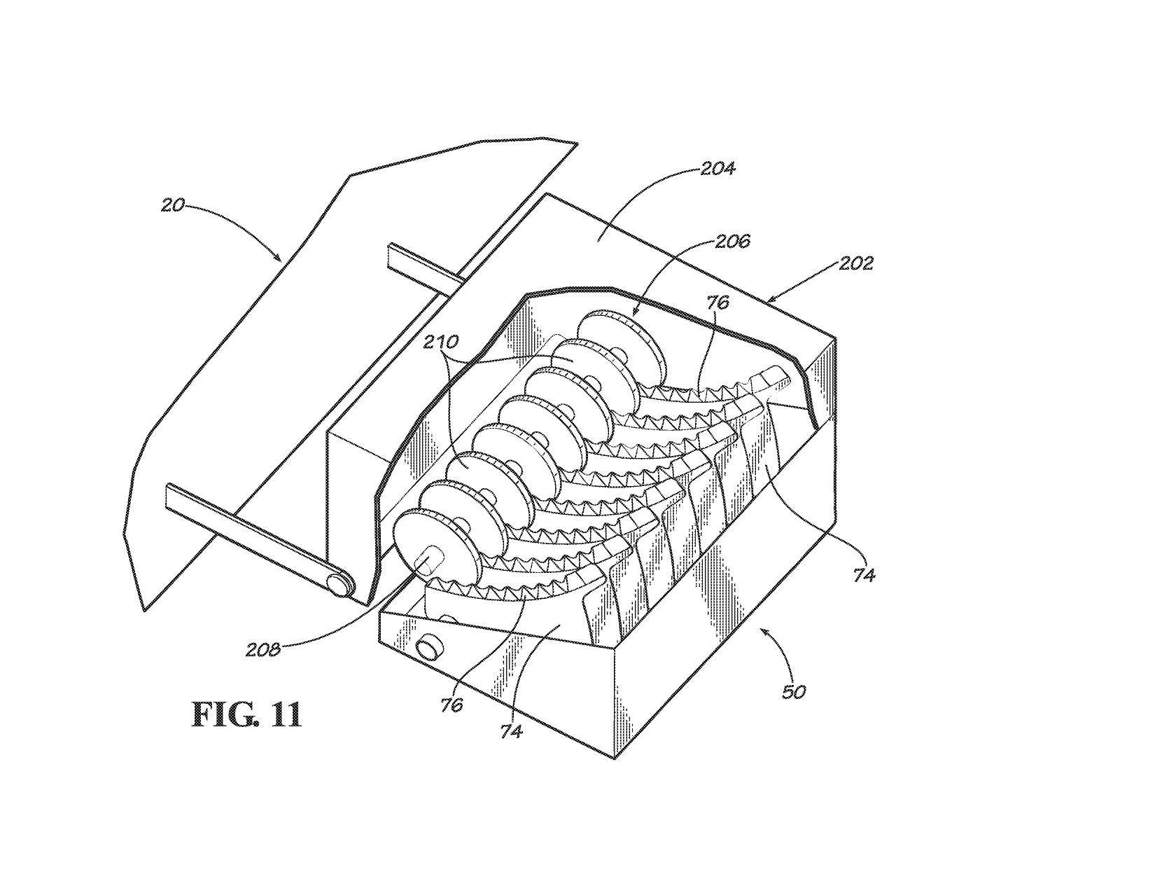

As shown schematically in FIG. 11, each of the knife-sharpening assemblies 202 comprises a hood 204 and a sharpening stone assembly 206. The sharpening stone assembly 206 preferably comprises a substantially horizontal rotatable shaft 208, a drive system (not shown) for the shaft 208, and a plurality of natural or synthetic sharpening stones 210 mounted to the shaft 208 in a spaced configuration. In a preferred embodiment, the drive system will utilize hydraulic power. However, any suitable drive arrangement is allowable.

Preferably, the number of stones 210 and their spacing correspond to the number of knives 74 and their spacing. Preferably, one stone 210 is provided for each knife 74; and the rotating shaft 208 is mounted such that it is operable for both vertical and fore-and-aft translation as necessary to allow the stones 210 to follow the arcuate contour of the smooth upper edges (i.e., the edges opposite the serrated edges 76) of the respective knives 74 during rotation and resulting sharpening. This arrangement is shown in FIG. 11, albeit without mounting structure for the shaft 208.

Fewer stones may be used if the rotating shaft is provided with means for lateral translation. For instance, a shaft 208 having one stone 210 for each pair of knives 74 could make a first fore-and-aft pass to sharpen every other knife 74, then shift laterally and make a second fore-and-aft pass to sharpen the remaining knives. A shaft 208 could even have a single stone 210 and make a fore-and-aft pass for each individual knife 74. Such a system is described in the Pottinger brochure entitled “Pottinger JUMBO/JUMBO combiline” (June 2011), which is attached as Appendix D and is hereby incorporated in its entirety by reference herein.

Alternatively, the system could be configured to avoid sharpening of selected knives. This would be desirable if, for example, only every other one of the knives 74 had been used during a cutting operation in order to achieve a desired cut crop length. The knives 74 that had not been used would still be sharp, and sharpening of them would lead to additional wear without providing any benefits. A variety of approaches to selective sharpening fall within the scope of the present invention. For instance, the actuating mechanism described previously could be adapted for operability when the knife beds 50a,50b are in their accessible lateral positions. The same knives 74 that were raised during the cutting operation could therefore be raised for sharpening, and the stones 210 for which a corresponding knife 74 was not raised would simply spin without contacting the retracted knife 74.

In another configuration meant to avoid sharpening of selected knives, a system could be implemented to selectively control which of the stones 210 were operable. One such approach could involve the mounting of each of the stones 210 on a respective stub shaft that can be driven by the main shaft 208 upon engagement of a respective clutch assembly. That is, each stone 210 could be mounted on a respective stub shaft engageable by a respective clutch associated with the rotating shaft 208, with each clutch being independently actuatable to allow selective rotation of the stones 210. The non-rotating stones 210 could be allowed to remain in position as the arcuate contour of the knives 74 is followed, or means for implementing a small lateral shift of the non-rotating stones 210 could be provided to ensure clearance between the non-rotating stones 210 and the smooth edges of the respective knives 74.

Although preferred embodiments are described herein, a variety of sharpening system configurations are permissible. For instance, rather than being circular in cross-section and rotating, the sharpening stones 210 could have rectangular cross-sections and be mounted for back-and-forth motion. A variety of grits or abrasives are acceptable, and both wet and dry sharpening systems fall within the scope of the present invention.

Fire precautions could be built in, as well. With regard to wet systems, for instance, a fluid comprising a coolant with a fire-retardant additive could be used. Alternatively, in either a wet or dry system, a fire-retardant composition could be independently available. For instance, a canister containing fire-retardant powder or pressurized foam could be attached to the hood 204. The canister could be activated automatically based on, for example, the presence of high amounts of smoke or extremely high temperatures. In another embodiment, a sprinkler system could be implemented within the system; or additional fire protection could be provided through oxygen deprivation resulting from formation of an airtight seal between the knife bed 50 and the hood 204.

Preferably, operation of the knife-sharpening assemblies 202 occurs as the baler 10 is in transit. For instance, the knife-sharpening assemblies 202 could be in operation as the baler 10 travels between fields, as will be described below. However, operation while the baler 10 is stationary is also permissible.

A preferred knife-sharpening operation sequence begins with the ceasing of the baling process. When the knives 74 are no longer operating to cut the crop and the baler 10 is stationary, the knife beds 50a,50b are lowered using the previously described hydraulic system or other suitable means, and the knives 74 are lowered into an inoperative position using an actuating mechanism such as that described previously. If necessary, any remaining bales are manually or automatically removed from the baling chamber 12. The beds 50a,50b are then slid laterally outwardly to the position best illustrated in FIG. 8, and the knives 74 are returned to an operative position.

The knife-sharpening assemblies 202a,202b and the knife beds 50a,50b are then brought into secure engagement, as shown in FIG. 10, such that each hood 204a,204b encompasses the respective knife bed 50a,50b to form a spark-retaining shield thereabout. Such engagement may be initiated by movement of the knife-sharpening assemblies 202a,202b; the knife beds 50a,50b; or of both. For instance, engagement may be achieved by the raising of the knife bed assemblies 50a,50b in addition to lowering or downward pivoting (as illustrated schematically in FIG. 10) of the knife-sharpening assemblies 202a,202b. Preferably, each of the knife-sharpening assemblies 202a,202b is moved downward toward the respective (stationary) knife bed assemblies 50a,50b.

Regardless of the particular approach, engagement may be initiated manually or automatically by a variety means. For instance, a spring system or a counterbalance could be provided to help support the weight of the sharpening assemblies 202a,202b to allow for manual movement, or a hydraulic system could be implemented for automatic movement.

The knife-sharpening assemblies 202a,202b and knife bed assemblies 50a,50b are then securely fixed to one another by latches, fasteners, or any suitable fixation means. The knife-sharpening assemblies 202a,202b and knife bed assemblies 50a,50b are then raised in unison to a sharpening/travel position (not illustrated) that provides sufficient ground clearance below the beds 50a,50b to allow for safe travel of the baler 10, and the sharpening operation begins. Preferably, ground clearance of two (2) feet is provided.

The unitary raising of the knife-sharpening assemblies 202a,202b and knife bed assemblies 50a,50b may be accomplished by a variety of means. (Note that raising means are not shown in FIGS. 9 and 10.) For instance, the unit might be configured to pivot upward about a lateral axis, or a system for direct vertical elevation might be provided. In a preferred embodiment, the cylinders 86 could be used to raise the attached knife bed assemblies 50a,50b and knife-sharpening assemblies 202a,202b.

Upon completion of the sharpening process, the system preferably remains in the sharpening/travel position until a return to the original cutting configuration is desired. For instance, the system could remain in the sharpening/travel position until the baler 10 has reached a new field and the operator is prepared to start a new baling operation. Preferably, the process by which the knife-sharpening assemblies 202a,202b and knife bed assemblies 50a,50b return to the cutting configuration is simply a reversal of the process by which they moved to the sharpening/travel position. First, the knife-sharpening assemblies 202a,202b and knife bed assemblies 50a,50b are unitarily lowered. Next, the hoods 204a,204b are pivoted upward from the beds 50a,50b and secured to the pickup 20 for storage. The knives 74 are lowered to an inoperative position, and the beds 50a,50b are slid back toward the center of the baler 10 so as to return to the cutting zone 30. The beds 50a,50b are raised, and the knives 74 are then raised into an operative position. At this stage, the baler 10 is operative to begin baling when desired by the operator.

The entire sharpening process may be controlled automatically, manually, or a mixture of both. For instance, a fully automated, timed system could be implemented; or the machine operator could trigger each individual step through a user interface provided in the cab. For example, in a mixed system, the operator might manually slide the beds 50a,50b out to their lateral accessible positions and raise the knives 74 in order to visually check the status of the knives 74 but allow an automated, timed system to control the sharpening stones 210 upon flipping of a switch in the cab. The operator could then initiate the automated return of the system to the cutting configuration by providing a command via a cab-based user interface. These and a variety of other process control approaches fall within the scope of the present invention.

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention.

What is claimed is:

1. An agricultural implement comprising:
an infeed cutter includes a plurality of knives, the knives being mounted on a pair of shiftable knife beds that swing into and out of an operating position; and
at least one knife-sharpening assembly for sharpening of the knives, said at least one knife sharpening assembly comprising a hood and a plurality of sharpening stones mounted on an at least substantially horizontally extending shaft, wherein the sharpening stones are configured for engagement with the knives and the shaft is mounted such that it moves along a path corresponding to the shape of cutting edges of the knives, and wherein the hood is configured to contain any sparks produced by the interaction of the stones and the knives.

2. The agricultural implement of claim 1 wherein the beds are also laterally slidable in opposite directions so as to provide access to the knives.

3. The agricultural implement of claim 1 wherein the implement includes a pair of knife-sharpening assemblies.

4. The agricultural implement of claim 1 wherein the sharpening stones follow a substantially arcuate contour of the uppermost edges of the knives during the course of sharpening.
